(19) United States
(12) Patent Application Publication
(10) Pub. No.: US 2026/0070404 A1
(43) Pub. Date: Mar. 12, 2026

(54) OFF-ROAD VEHICLE

(71) Applicant: Polaris Industries Inc., Medina, MN (US)

(72) Inventors: Andrew C. Schleif, Stacy, MN (US); Paul W. Barton, Warwickshire (GB); Ralph W. Lauzze, III, Hugo, MN (US); Robert C. Wilmot, Stacy, MN (US); Anthony J. Ripley, Ham Lake, MN (US); Brian R. Gillingham, Osceola, WI (US)

(21) Appl. No.: 19/193,578

(22) Filed: Apr. 29, 2025

Related U.S. Application Data
(63) Continuation of application No. 18/367,952, filed on Sep. 13, 2023, now Pat. No. 12,337,690.
Application No. 18/367,952 is a division of application No. 16/875,448, filed on May 15, 2020, now Pat. No. 12,187,127.

(51) Int. Cl. B60K 5/02; B60K 5/04; B60K 13/02; B60K 13/04; B60K 17/00; B60K 17/06; B60K 17/22; F02B 37/00; F02F 7/00; F16H 9/16

(52) U.S. Cl. CPC B60K 5/02; B60K 5/04; B60K 13/02; B60K 13/04; B60K 17/00; B60K 17/06; B60K 17/22; F02B 37/00; F02F 7/0021; F16H 9/16

(57) ABSTRACT

A vehicle shown herein is a side by side utility vehicle having a powertrain an engine with at least three cylinders, an intake and an exhaust, where the intake is forward of the engine and the exhaust is rearward of the engine. The vehicle may further or alternatively include an engine block configured to couple with various transmissions without alteration of the engine block itself.

### CROSS-REFERENCE TO RELATED APPLICATION

The present application is a continuation of U.S. patent application Ser. No. 18/367,952, filed Sep. 13, 2023, which application is a divisional of U.S. patent application Ser. No. 16/875,448, filed May 15, 2020, issued on Jan. 7, 2025 as U.S. Pat. No. 12,187,127, the entire disclosures of which are incorporated herein by reference.

### FIELD OF THE INVENTION

The present invention relates to off-road vehicles including all-terrain vehicles (“ATVs”) or utility vehicles (“UTVs”).

### BACKGROUND OF THE INVENTION

Generally, UTVs or ATVs are used to carry one or more passengers and a small amount of cargo over a variety of terrains. Due to different terrains and user preferences, however, a variety of engine power requirements and vehicle sizes may be desired. Current UTVs and ATVs typically provide two-or four-cylinder engines. However, two-cylinder engine UTVs and ATVs may provide too little power for certain operating or terrain conditions, while four-cylinder engine UTVs and ATVs may be oversized or too large for various users, conditions, etc. Thus, a need exists for a UTV or ATV that is configured for enhanced power while also remaining compact and trail compatible.

In addition, current UTVs and ATVs typically require a different engine block for each different transmission and/or configurations. Thus, a need exists for an engine block that is capable of supporting different transmission and/or powertrain configurations without alteration of the engine block itself.

### SUMMARY OF THE INVENTION

In one embodiment of the disclosure, a utility vehicle comprises a frame, a body supported by the frame, a seating area supported by the frame, front and rear ground engaging members supporting the frame and the body, and a powertrain drivingly coupled to the front and rear ground engaging members. The powertrain comprises a transmission and an engine having at least three cylinders, an intake, and an exhaust. The intake is positioned longitudinally forward of the engine and the exhaust is positioned longitudinally rearward of the engine,

In another embodiment of the disclosure, a utility vehicle comprises a frame, a body supported by the frame, a seating area supported by the frame, front and rear ground engaging members supporting the frame and the body, and a powertrain drivingly coupled to the front and rear ground engaging members. The powertrain comprises a transmission and an engine having at least three cylinders, an intake, and an exhaust. The intake is positioned between the seating area and the engine. The engine is positioned between the intake and the exhaust, and the exhaust is positioned between the engine and a rear of the utility vehicle.

In yet another embodiment, a utility vehicle comprises a frame, a body supported by the frame, front and rear ground engaging members supporting the frame and the body, and a powertrain drivingly coupled to the front and rear ground engaging members. The powertrain comprises a transmission and an engine. The engine has an engine block and a crankshaft. The transmission includes one of a first type of transmission and a second type of transmission. The engine block being configured to couple to either of the first type of transmission and the second type of transmission without alteration of the engine block.

### BRIEF DESCRIPTION OF THE DRAWINGS

FIG. 1 shows a front left perspective view of a vehicle of the present disclosure;

FIG. 2 shows a right rear perspective view of the vehicle of FIG. 1;

FIG. 3 shows a left elevational side view of the vehicle of FIG. 1;

FIG. 4 shows a right elevational side view of the vehicle of FIG. 1;

FIG. 5 shows a top plan view of the vehicle of FIG. 1;

FIG. 6 shows a front elevational view of the vehicle of FIG. 1;

FIG. 7 shows a rear elevational view of the vehicle of FIG. 1;

FIG. 8 shows a front elevation view of front ground engaging members, a front suspension assembly, and a portion of a frame of the vehicle of FIG. 1;

FIG. 9 shows a plan view of a linear force element of the front suspension assembly of FIG. 8 including a first embodiment of a body assembly of the linear force element and a reservoir of the linear force element;

FIG. 10 shows a plan view of a second embodiment of a body assembly of the linear force element of the front suspension assembly of FIG. 8;

FIG. 11 shows a top plan view of the vehicle of FIG. 1 with a schematic view of a first embodiment of a powertrain of the vehicle of FIG. 1;

FIG. 12 shows a top plan view of the vehicle of FIG. 1 with a schematic view of a second embodiment of a powertrain of the vehicle of FIG. 1;

FIG. 13 shows a top plan view of the vehicle of FIG. 1 with a schematic view of a third embodiment of a powertrain of the vehicle of FIG. 1;

FIG. 14 shows a detailed view of exhaust ports of an engine of a powertrain of the vehicle of FIG. 1 and a portion of an exhaust assembly of the present disclosure;

FIG. 15 shows a top plan view of the first embodiment of the powertrain of FIG. 11;

FIG. 16 shows a perspective view of a transmission of the powertrain of FIG. 15;

FIG. 17 shows a detailed front perspective view of the transmission of FIG. 15;

FIG. 18 shows a top plan view of the third embodiment of the powertrain of FIG. 13;

FIG. 19 shows a perspective view of a transmission of the powertrain of FIG. 18;

FIG. 20 shows a detailed bottom plan view of a portion of the vehicle of FIG. 1;

FIG. 21 shows a perspective view of an embodiment of an exhaust system of a powertrain of the vehicle of FIG. 1;

FIG. 22 shows a cross-sectional view of a muffler of the exhaust system of FIG. 21 taken along line 22-22 in FIG. 21;

FIG. 23 shows an enlarged perspective view of an embodiment of a coupling between a transmission and an engine of the vehicle of FIG. 1;

FIG. 24 shows an exploded view of the coupling between the transmission and the engine of FIG. 23;

FIG. 25A shows a perspective view of a first embodiment of a crankshaft of the present disclosure;

FIG. 25B shows a perspective view of a second embodiment of a crankshaft of the present disclosure;

FIG. 26 shows a cross-sectional view of the powertrain of FIG. 15 taken along line 26-26 of FIG. 15;

FIG. 27 shows a side plan view of a belt and pulley system of the present disclosure coupled to an engine of the vehicle of FIG. 1;

FIG. 28 shows a perspective view of the engine and the belt and pulley system of FIG. 27 with a cover positioned over the belt and pulley system;

FIG. 29 shows an exploded view of the engine and the cover of FIG. 28;

FIG. 30 shows an exploded view of the cover of FIG. 28;

FIG. 31 shows an exploded view of a compressor and a first embodiment of a compressor mount of the present disclosure relative to an engine of the vehicle of FIG. 1;

FIG. 32 shows a perspective view of a compressor and a second embodiment of a compressor mount of the present disclosure relative to an engine and an engine mount of the vehicle of FIG. 1;

FIG. 33 shows an exploded view of the compressor, the second embodiment of the compressor mount, the engine, and the engine mount of FIG. 32;

FIG. 34 shows a detailed bottom plan view of a drive shaft and an oil pan of an engine of the present disclosure;

FIG. 35 shows a cross-sectional view of the drive shaft and the oil pan of FIG. 33 taken along line 35-35 of FIG. 34;

FIG. 36 shows an enlarged perspective view of a top of an engine of the present disclosure, where the engine includes a variable valve timing or phasing system protected by a cam cover;

FIG. 37 shows an enlarged perspective view of a top of an engine of the present disclosure, where the engine includes a first variable valve timing or phasing system and a second variable valve timing or phasing system concealed by a cam cover;

FIG. 38 shows an exploded view of the first variable valve timing or phasing system of FIG. 36, noting that the configuration of the second variable valve timing or phasing system may be identical or similar to that of the first variable valve timing or phasing system; and FIG. 39 shows a cross-sectional view of the first variable valve timing or phasing system and the engine of FIG. 36 taken along line 39-39 of FIG. 36.

### DETAILED DESCRIPTION OF THE DRAWINGS

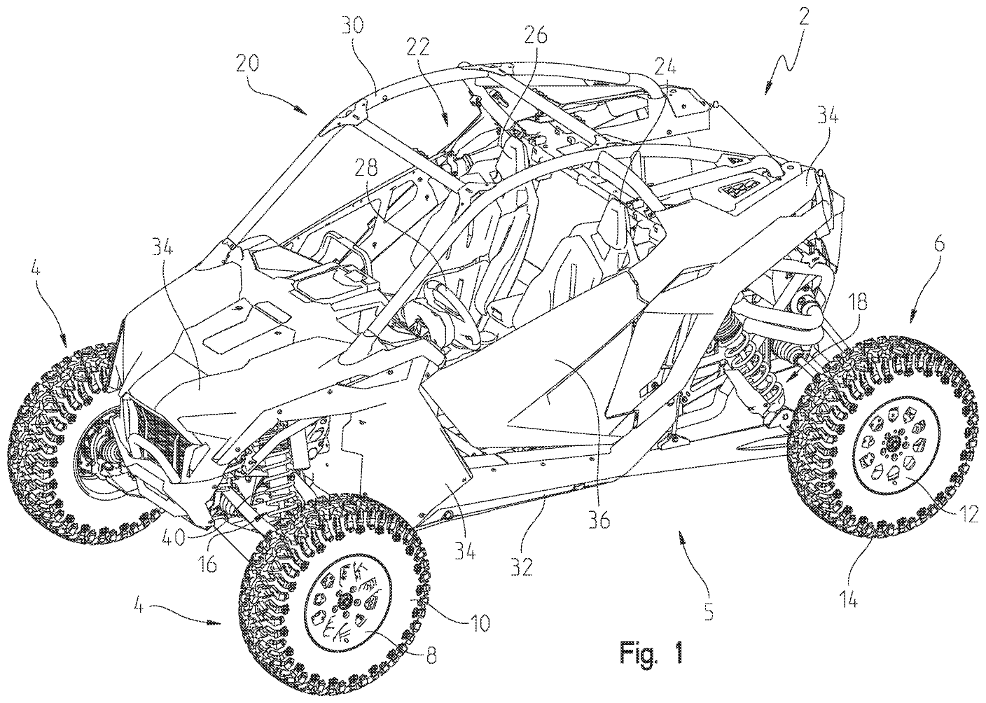

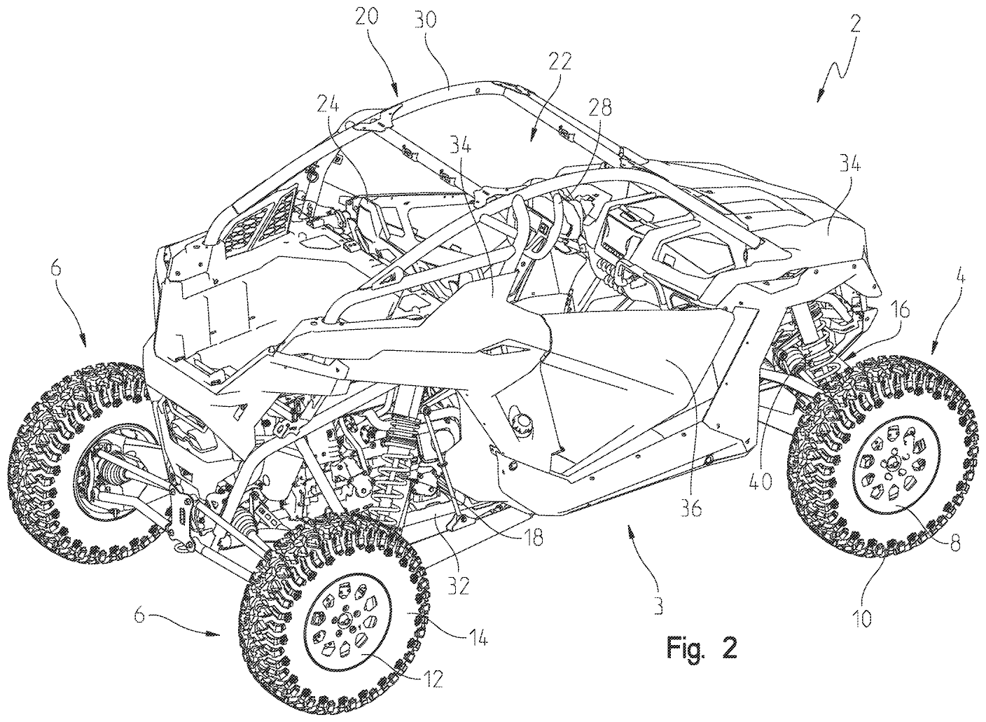

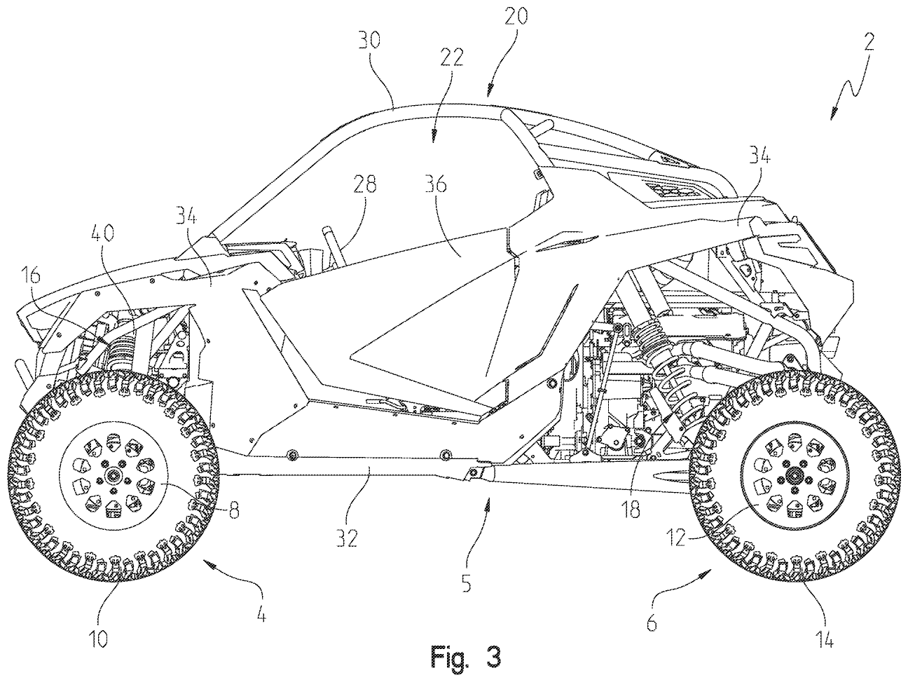

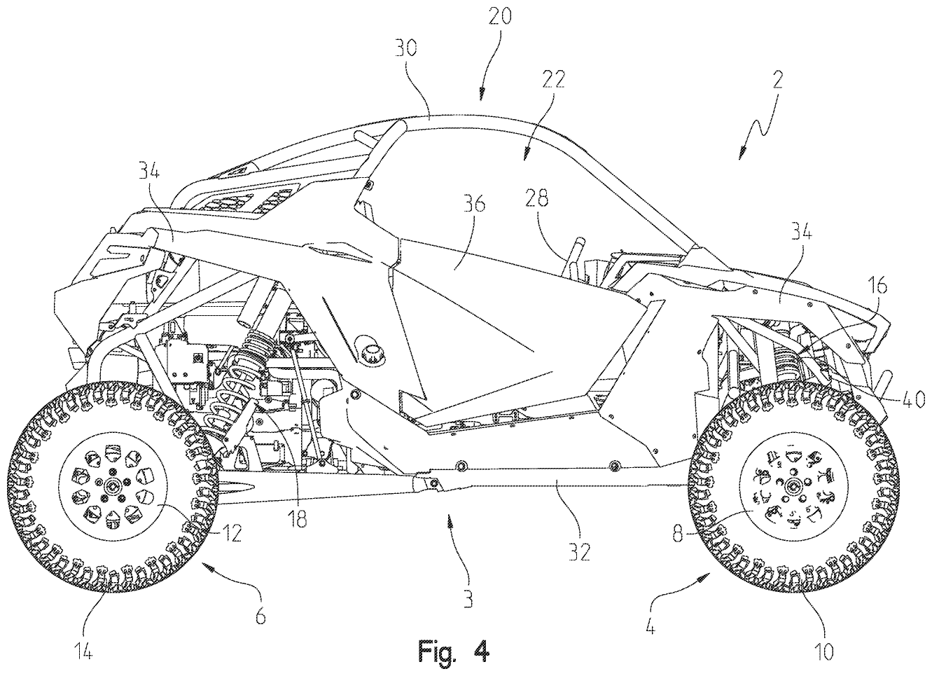

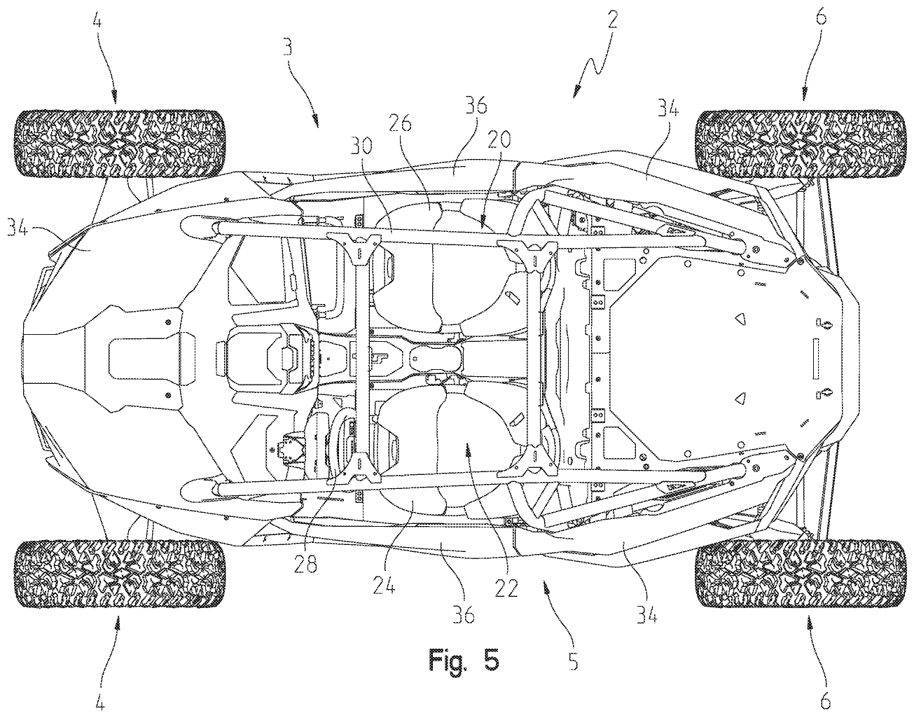

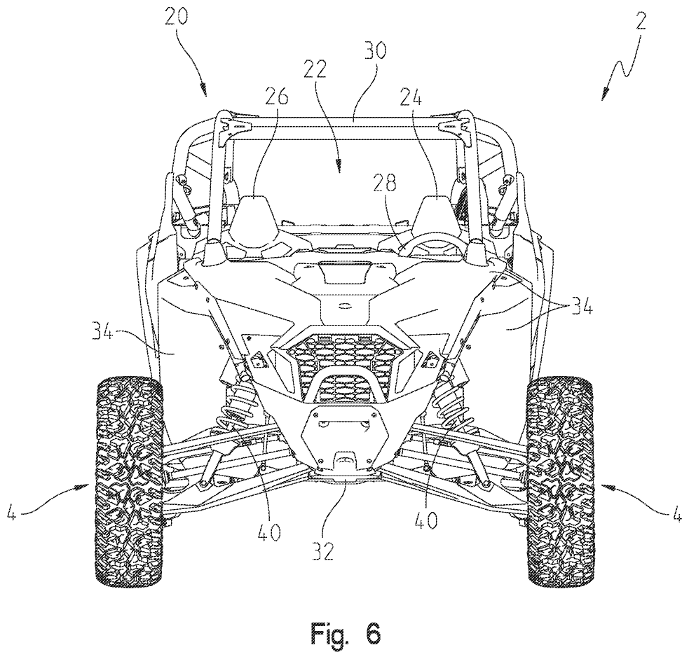

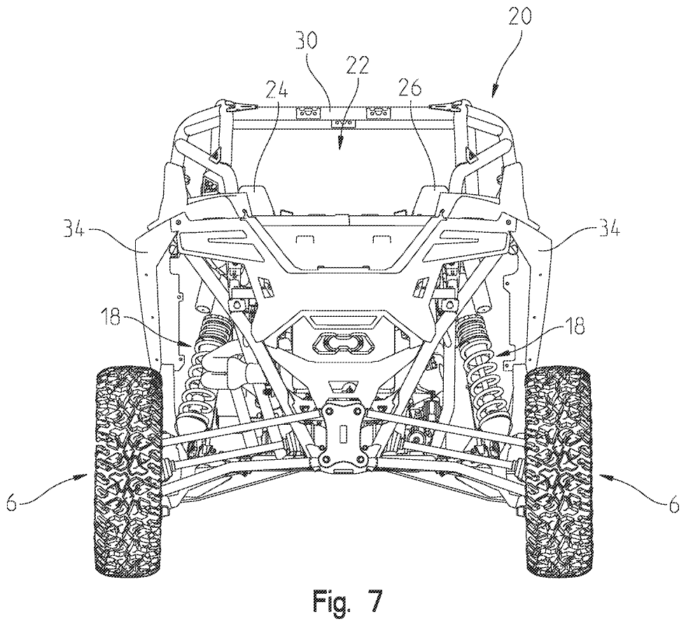

With reference to FIGS. 1-7, the vehicle of the present disclosure will be described. As shown, the vehicle is generally depicted as reference number 2 which includes front ground engaging members 4 and rear ground engaging members 6. Front ground engaging members 4 are comprised of wheels 8 and tires 10, and rear ground engaging members 6 are comprised of wheels 12 and tires 14. Ground engaging members 4 and 6 support a vehicle frame, which is shown generally at 20, through front and rear suspension assemblies 16 and 18.

Vehicle frame 20 supports a seating area 22 comprised of at least a driver's seat 24 and a passenger seat 26. Vehicle 2 further includes a steering assembly for steering front ground engaging members 4 whereby the steering assembly includes a steering wheel 28. Frame 20 of vehicle 2 is comprised of a cab frame 30 that generally extends over the seating area 22, and a lower frame portion 32 positioned below and supporting cab frame 30. Frame 20 is configured to support a plurality of body panels 34 and/or doors 36.

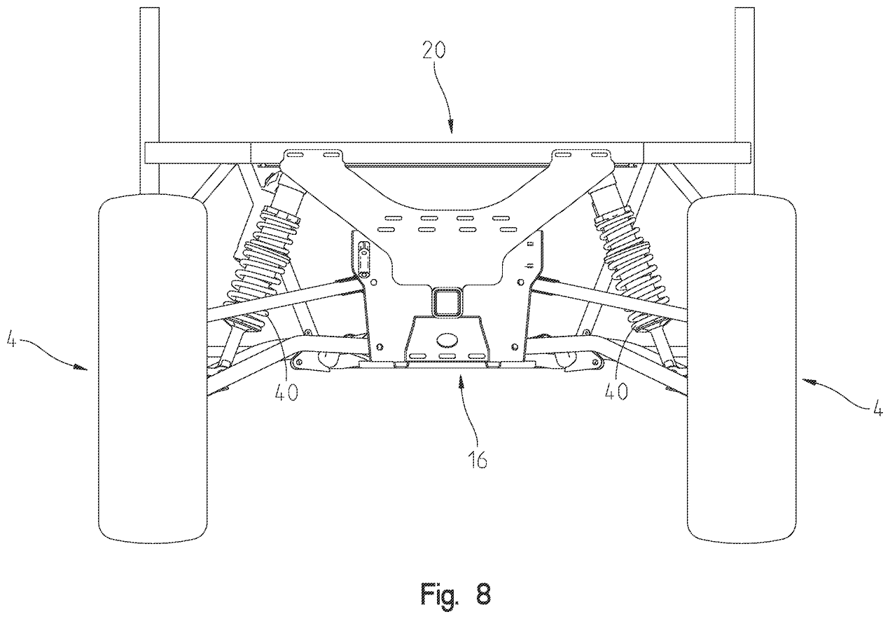

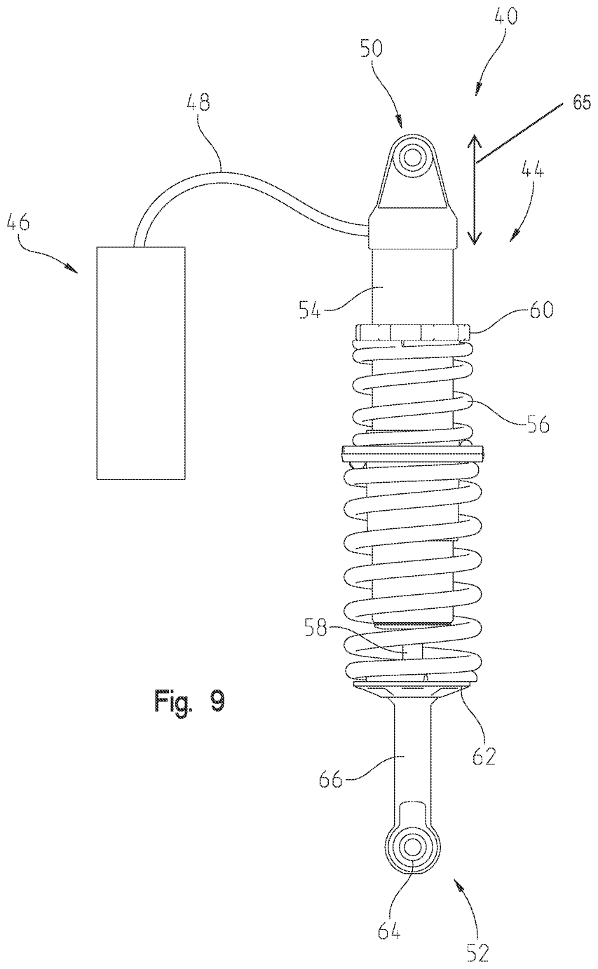

Referring now to FIGS. 8-10, front suspension assembly 16 generally includes a set of linear force elements 40. Linear force elements 40 each generally include a body assembly 44, 44′ and a reservoir 46 fluidly coupled to body assembly 44, 44′ via a conduit 48. Reservoir 46 is generally mounted to frame 20 or another component of vehicle 2 at a position spaced apart from body assembly 44, 44′ to allow for proper packaging of linear force elements 40.

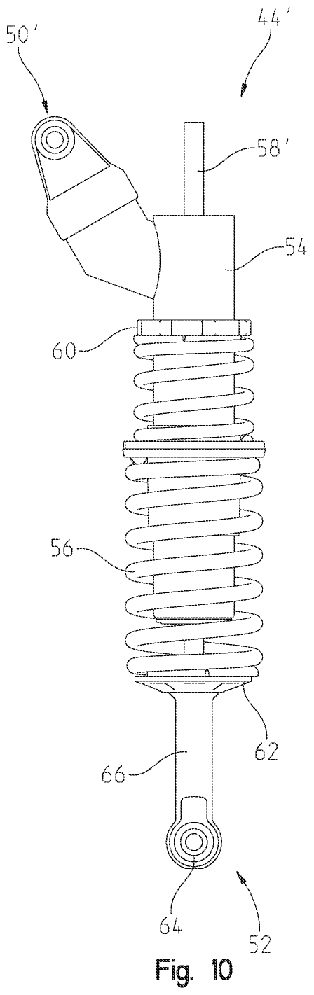

Body assembly 44, 44′ of linear force element 40 generally includes a first mount 50, 50′ coupled to frame 20, a second mount 52 operably coupled to one of front ground engaging members 4 (e.g., through an additional component(s) of front suspension assembly 16), a pressurized cylinder 54 fluidly coupled to reservoir 46, a spring 56 surrounding cylinder 54 and held between a first spring seat 60 coupled around an upper portion of cylinder 54 and a second spring seat 62 coupled to second mount 52, and a shaft 58 extending from second spring seat 62 into cylinder 54. In various embodiments, linear force elements 40 may be through-rod shocks such that shaft 58′ extends through and out of both ends of cylinder 54 (FIG. 10).

Still referring to FIGS. 8-10, second mount 52 of body assembly 44, 44′ generally includes an eyelet 64 operably coupled to ground engaging member 4 (e.g., through a lower control arm of front suspension assembly 16) and a rod 66, where rod 66 extends from eyelet 64 to second spring seat 62. Rod 66 is generally longer than previous rods on UTV or ATV linear force elements such that spring 56 is moved upward toward first mount 50 allowing a shock point of vehicle 2 to be closer to ground engaging members 4. In one embodiment, eyelet 64 has a length 65 of at least 2.25 inches. For example, eyelet 64 may have a length 65 of up to at least 5.10 inches. Length 65 of eyelet 64 and the overall configuration of linear force elements 40 may allow linear force elements 40 to be moved, for example outwardly, to accommodate the size or position of other components, such as engine 72.

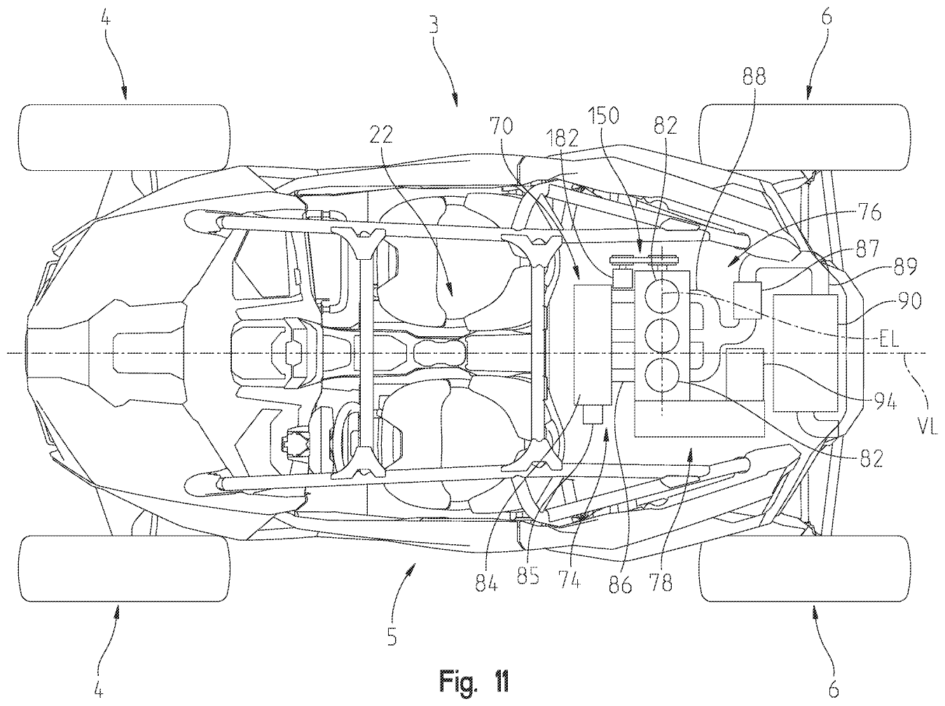

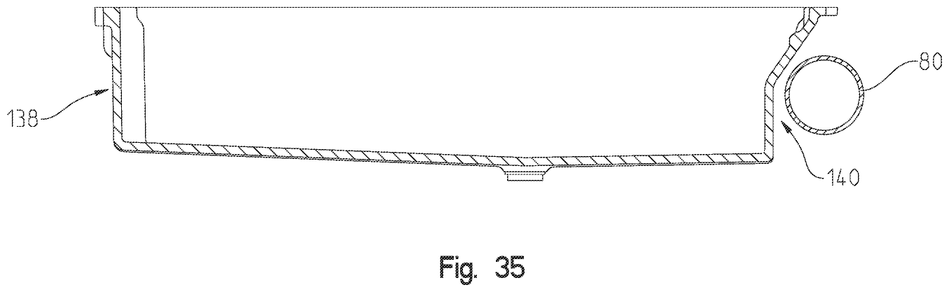

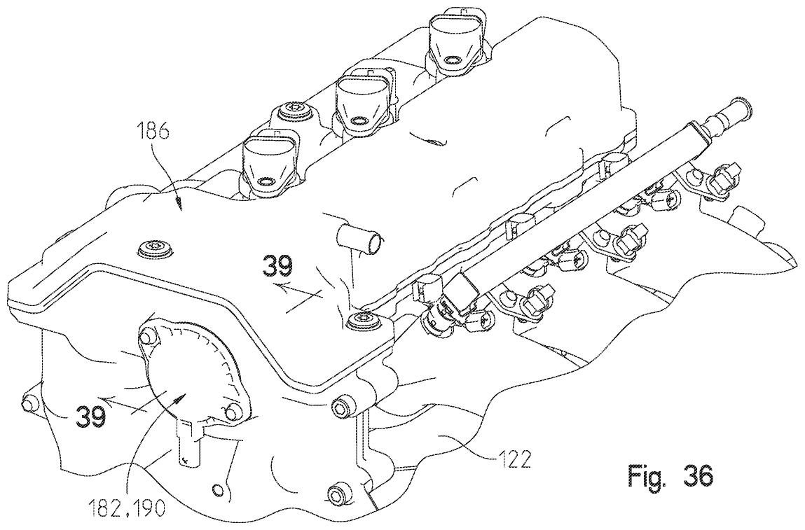

With reference now to FIGS. 11-13, vehicle 2 further includes a powertrain assembly 70 for providing power to ground engaging members 4 and 6 of vehicle 2. Powertrain assembly 70 generally comprises an engine 72, an engine intake manifold assembly 74 providing air to engine 72, an exhaust assembly 76 routing exhaust from engine 72 out of vehicle 2, a transmission 78 operably coupled to engine 72, and a drivetrain having a drive shaft 80 (FIGS. 34 and 35) coupled to transmission 78. Additional details relating to powertrain assembly 70 and/or engine 72 may be found in U.S. patent application Ser. No. ______ (Attorney Docket Number PLR-15-29110.02P-US), filed concurrently with the present application, the subject matter of which is incorporated herein by reference.

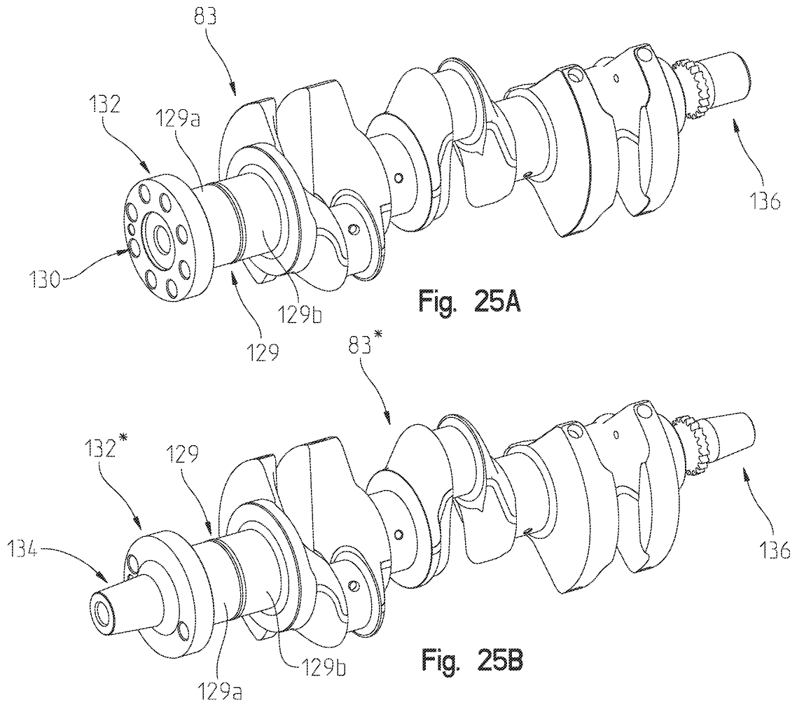

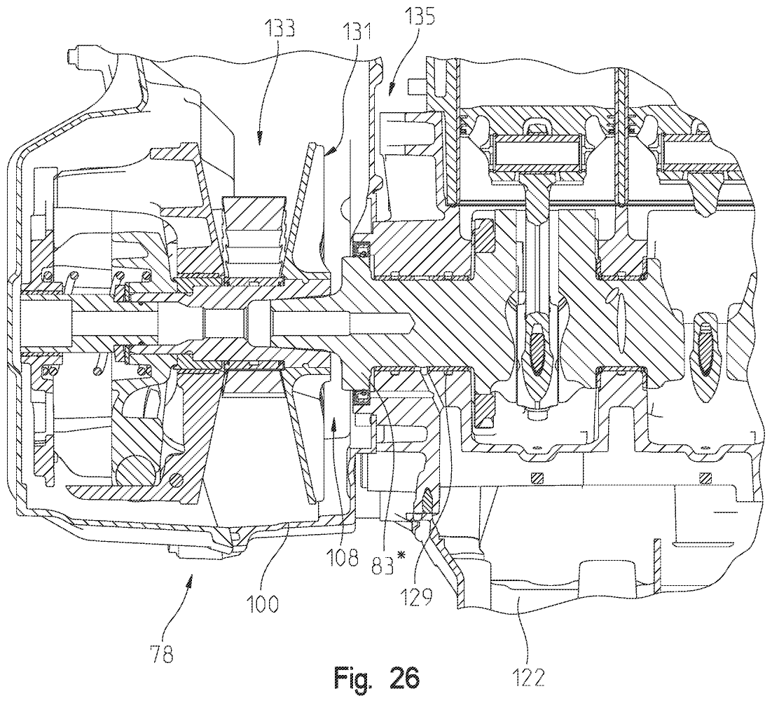

Engine 72 of powertrain assembly 70 generally includes up to three cylinders 82 and a crankshaft 83 (FIGS. 25A and 25B), and may be placed in vehicle 2 in a plurality of different configurations, with the present application illustrating at least two of these different configurations. In the first illustrative configuration, shown in FIG. 11, engine 72 is positioned in vehicle 2 in a transverse or East/West configuration, where cylinders 82 of engine 72 are aligned from a right side 3 of vehicle 2 to a left side 5 of vehicle 2 and crankshaft 83 extends laterally between right side 3 and left side 5 of vehicle 2 such that engine 72 is perpendicular to a longitudinal axis VL of vehicle 2. When engine 72 is in the transverse configuration, engine intake manifold assembly 74, which includes intake manifold 84, at least one throttle body 85, and/or intake manifold runners 86, is positioned generally forward of engine 72 and rearward of seating area 22 such that a majority of engine intake manifold assembly 74 is between seating area 22 and a forwardmost point of engine 72 and all of engine intake manifold assembly 74 is longitudinally between seating area 22 and a centerline EL of engine 72. Centerline EL of engine 72 is defined, in the first illustrative embodiment, as the laterally-extending centerline of cylinders 82 such that centerline EL intersects the midpoint or the vertically-extending reciprocation axis (e.g., reciprocation of a piston (not shown) therein) of each cylinder 82.

Exhaust assembly 76 of the first illustrative configuration (FIG. 11), which includes an exhaust manifold 88, at least one exhaust conduit 89, and/or a muffler or silencer 90, is positioned generally rearward of engine 72 and forward of a rear of vehicle 2 such that at least exhaust manifold and muffler 90 of exhaust assembly 76 are longitudinally between engine 72 and the rearwardmost point of vehicle 2. It may be appreciated that a portion of a tail pipe of exhaust assembly 76 may extend rearwardly from the rear of vehicle 2 without departing from the description and understanding of exhaust assembly 76 disclosed herein.

Transmission 78 of the first illustrative configuration (FIG. 11) is laterally positioned between engine 72 and right side 3 or left side 5 of vehicle 2 such that transmission 78 extends along a right side or a left side of engine 72. Transmission 78 also may be positioned rearward of at least a portion of engine intake manifold assembly 74 and forward of at least a portion of exhaust assembly 76. Illustratively, transmission 78 is positioned laterally between engine 72 and left side 5 of vehicle 2.

The configuration of powertrain assembly 70 of the first illustrative configuration (FIG. 11) allows for powertrain assembly 70 to have a hot side and a cold side. More particularly, a hot side of engine 72, or the side of engine 72 which contains more heat producing components, is generally defined as the rearward portion of engine 72 (e.g., may be defined as the portion of at least engine 72 positioned rearward of engine centerline EL). The hot side of engine 72 includes heat-producing components such as exhaust manifold 88 which contains hot air exhaust from engine 72 and other such components that may experience elevated temperatures during operation of engine 72 compared to other components. Additionally, a cool/cold side of engine 72, or the side of engine 72 which generates less heat, is generally defined as the forward portion of engine 72 adjacent seating area 22 (e.g., may be defined as the portion of at least engine 72 positioned forward of engine centerline EL). The cool side of engine 72 includes components that generate no or less heat such as engine intake manifold assembly 74 which receives ambient air and other such components that do not experience elevated temperatures during operation of engine 72. Because the cool side of engine 72 does not generate heat or generate as much heat as the hot side of engine 72, various heat sensitive components of powertrain assembly 70 and/or vehicle 2 may be positioned within or adjacent to the cool side of engine 72, such as electronics like sensors, controllers, etc. In addition to the strategic positioning of a hot and cold side of engine 72, this first illustrative configuration allows for throttle body 85 to be closer to intake manifold 84 resulting in a shorter intake assembly 74.

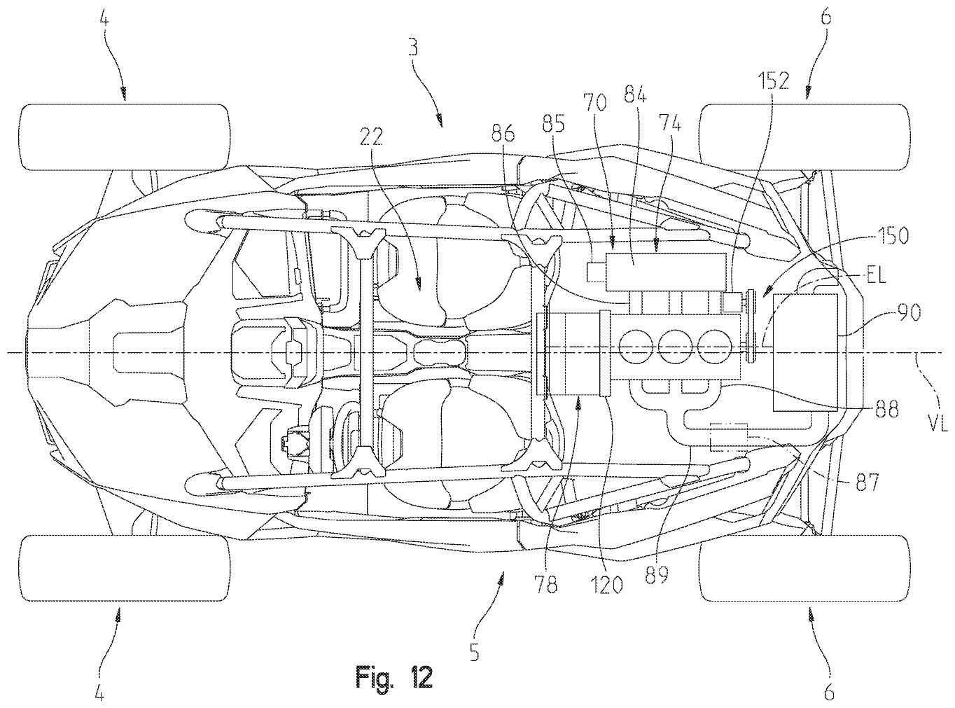

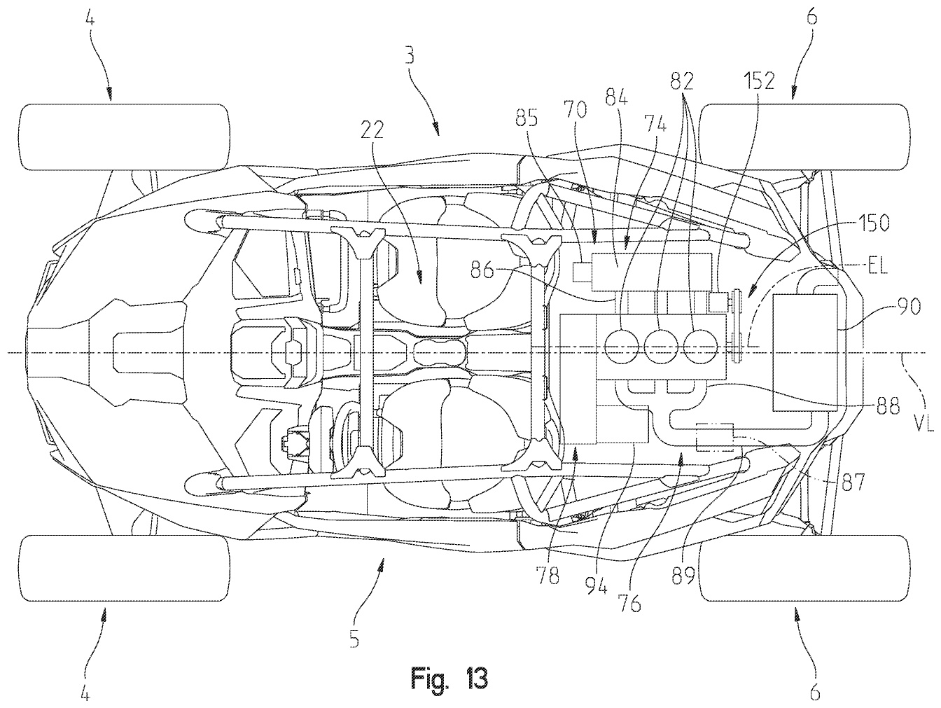

In the second illustrative configuration, shown in FIGS. 12 and 13, engine 72 is positioned in vehicle 2 in a longitudinal or North/South configuration, where cylinders 82 of engine 72 are aligned in the fore/aft direction of vehicle 2 and crankshaft 83 extends longitudinally such that engine centerline EL of engine 72 may be at least parallel to longitudinal axis VL of vehicle 2. In other embodiments, engine centerline EL may be colinear with longitudinal axis VL. As shown in FIGS. 12 and 13, when engine 72 is in the longitudinal/second illustrative configuration, longitudinal centerline EL of engine 72 may be offset to the right of longitudinal axis VL of vehicle 2 in order to allow an output shaft (not shown) and drive shaft 80 of the drivetrain to be properly aligned. When engine 72 is in the second or longitudinal configuration, engine intake manifold assembly 74 is positioned laterally between right side 3 of vehicle 2 and engine 72, portions of exhaust assembly 76 extend along left side 5 of vehicle 2 to a position rearward of engine 72, and transmission 78 may be positioned longitudinally forward of engine 72. In various embodiments, at least a portion of transmission 78 may be positioned below seating area 22 and/or rearward of seating area 22. As such, transmission 78 may be longitudinally intermediate a portion of seating area 22 and a portion of engine 72.

In either the first or second illustrative configurations, powertrain assembly 70 may further include a turbocharger 87, which may be positioned behind engine 72 in the transverse configuration of FIG. 11 or behind or to the side of engine 72 in the longitudinal configuration of FIGS. 12 and 13. However, in various embodiments, turbocharger 87 may be positioned at any location along exhaust conduit 89 between exhaust manifold 88 and muffler 90. In some embodiments, turbocharger 87 may be integrated within a portion of exhaust manifold 88 and/or positioned immediately adjacent exhaust manifold 88.

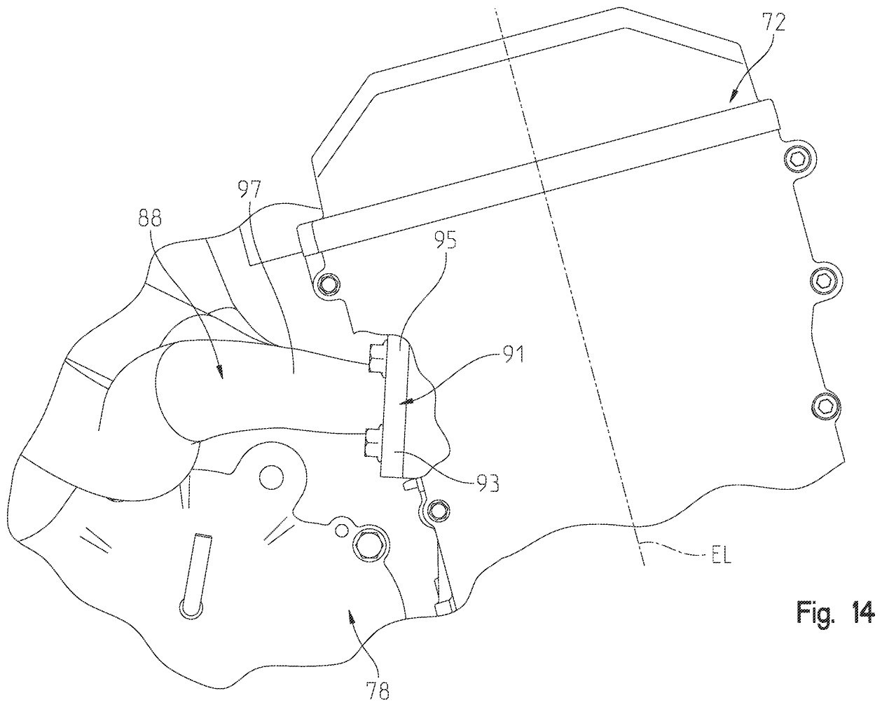

With reference to FIG. 14, engine 72 generally further includes exhaust ports 91. In various embodiments, exhaust ports 91 may be angled upward such that a lower surface 93 extends out further relative to centerline EL of engine 72 than an upper surface 95. Angled exhaust ports 91 allow exhaust manifold 88 and/or exhaust conduit(s) 89 to extend straight for a length 97 which may improve performance of vehicle 2 and allows transmission 78 to be packaged beneath exhaust ports 91, exhaust manifold 88, and/or exhaust conduit(s) 89, if desired.

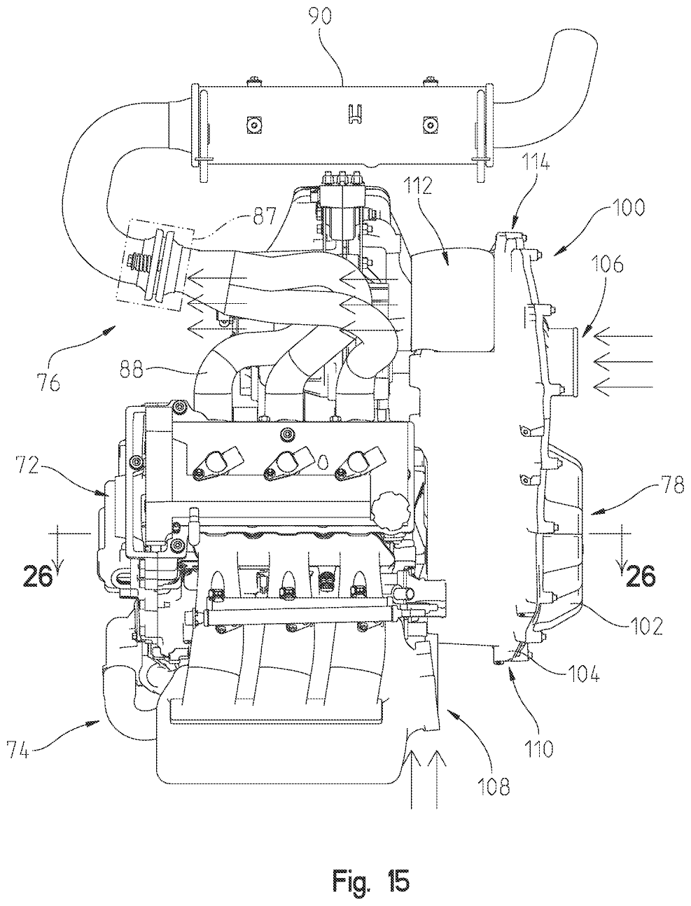

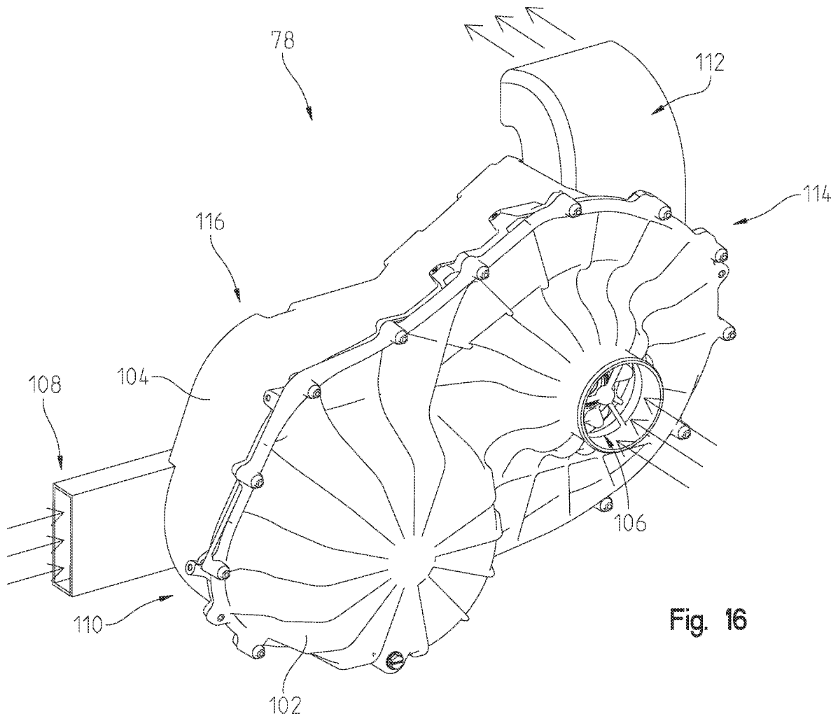

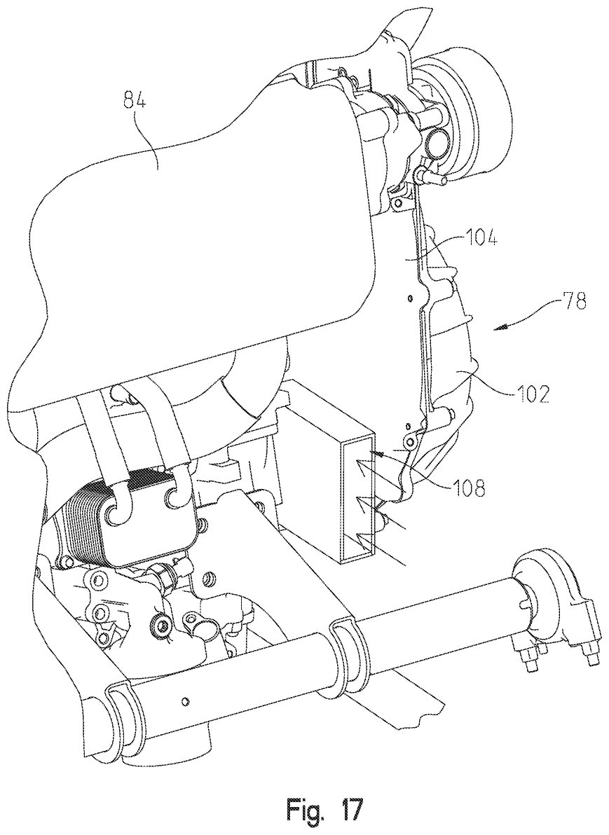

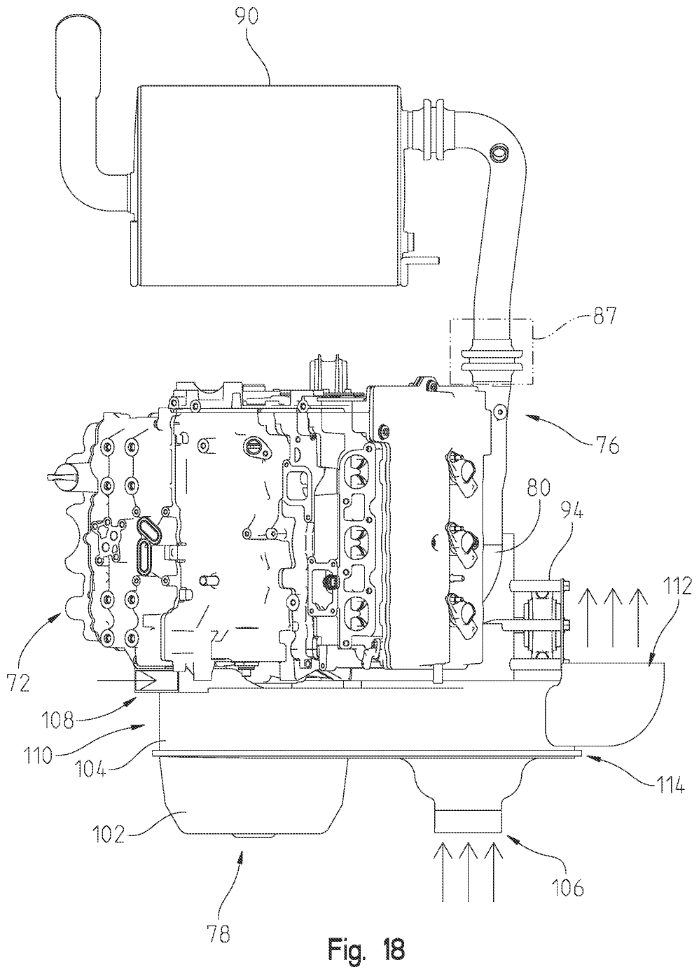

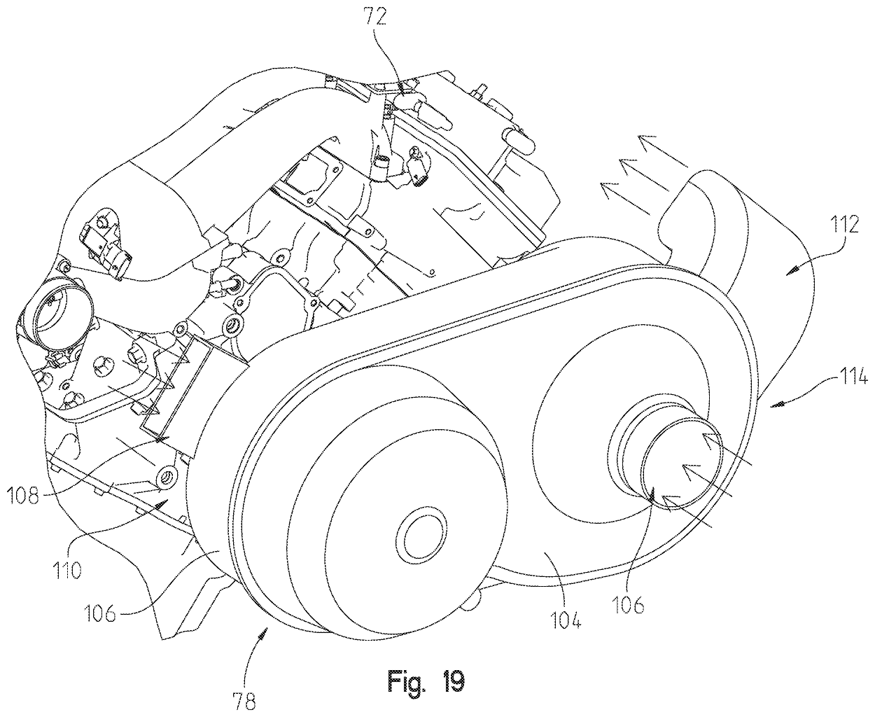

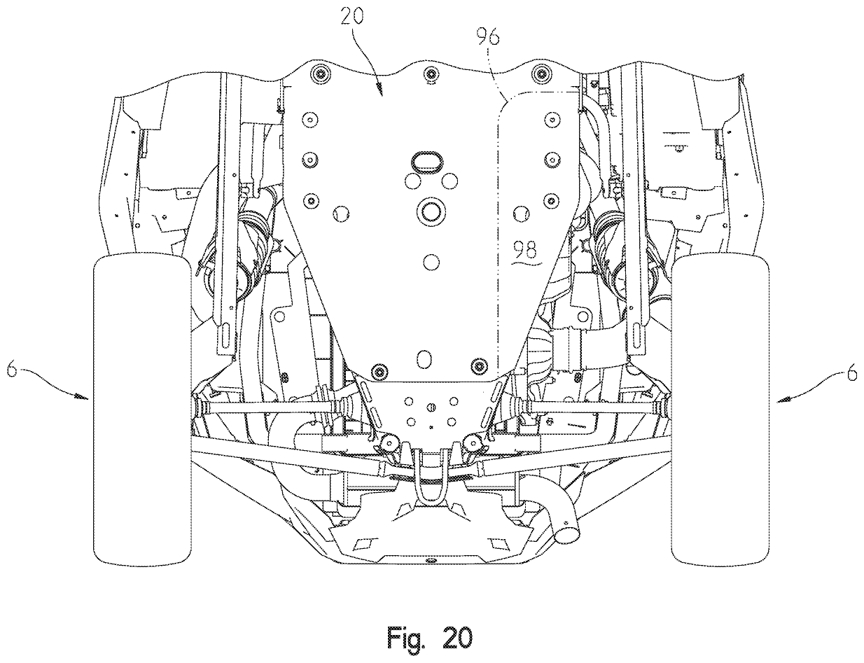

Referring now to FIGS. 11-13 and 15-20, transmission 78 of powertrain 70 may be a shiftable transmission or a continuously variable transmission (“CVT”), which may be an electronically controlled CVT (“eCVT”), a steel belt CVT and/or a rubber belt CVT. Further details relating to steel belt CVTs may be found in U.S. Patent Application Ser. No. 62/961,442 (Attorney Docket Number PLR-06-28903.01P-US), filed Jan. 15, 2020, the subject matter of which is incorporated herein by reference. In various embodiments, transmission 78 may also include a transmission gear set 94. Furthermore, as shown in FIG. 20, frame 20 may include a cutout 96 below transmission 78 such that portion 98 is removed or missing from frame 20, which allows access to transmission 78 for service without disassembling any portion of frame 20. Portion 98 may be a removable portion of frame 20 or may be entirely missing from frame 20.

Still referring to FIGS. 11-13 and 15-19, transmission 78 generally includes a housing 100 having a first portion 102 and a second portion 104, where second portion 104 may be directly or indirectly coupled to engine 72 and first portion 102 is coupled to second portion 104. First portion 102 generally includes a first inlet 106 adjacent a driven clutch (not shown), and second portion 104 generally includes a second inlet 108 extending from a first end 110 of second portion 104 adjacent a drive clutch (not shown) of CVT 92. Second portion 104 also includes an exhaust duct 112 extending from a second end 114 of second portion 104 adjacent the driven clutch of CVT 92. In the transverse configuration, second inlet 108 extends towards and faces the front of vehicle 2, while in the longitudinal configuration, second inlet 108 extends towards and faces right side 3 of vehicle 2. In various embodiments, second inlet 108 is positioned towards an inner surface 116 of second portion 104 adjacent engine 72 and between the drive clutch of CVT 92 and engine 72.

Exhaust duct 112 extends generally upward from second end 114 of second portion 104 such that exhaust of transmission 78 flows towards (e.g., over and around) at least a portion of exhaust assembly 76. For example, exhaust air from exhaust duct 112 of transmission 78 may flow over exhaust manifold 88, exhaust conduit(s) 89, turbocharger 87, and/or transmission gear set 94. The exhaust from transmission 78 allows heat from exhaust assembly 76 to be evacuated from behind a close off panel (not shown) behind seating area 22. More particularly, while the air from exhaust duct 112 may be elevated relative to the incoming ambient air through inlets 106, 108, the air from exhaust duct 112 may be cooler than various components of exhaust assembly 76 such that the exhausted air from transmission 78 facilitates cooling of at least a portion of exhaust assembly 76. In various embodiments, a cooler or fan (not shown) may be positioned adjacent exhaust duct 112 to allow for additional cooling of exhaust assembly 76.

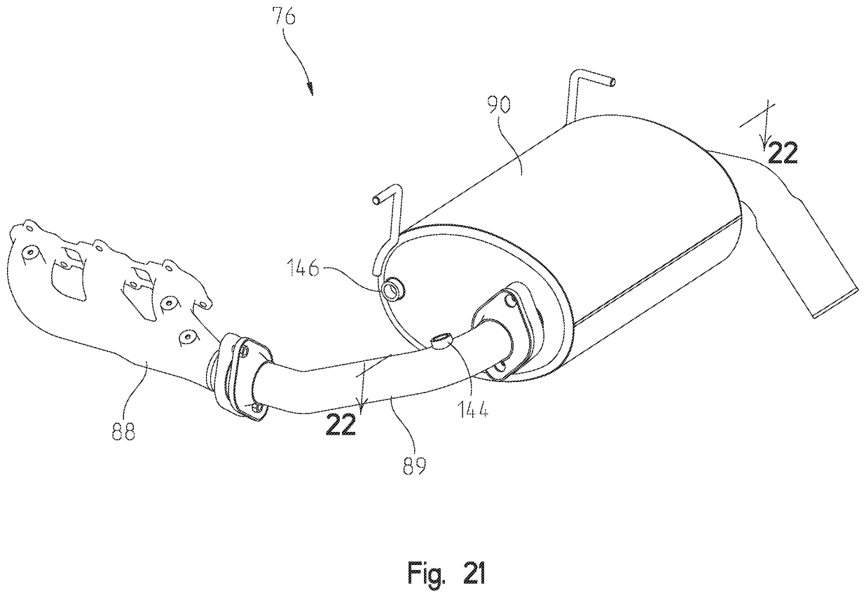

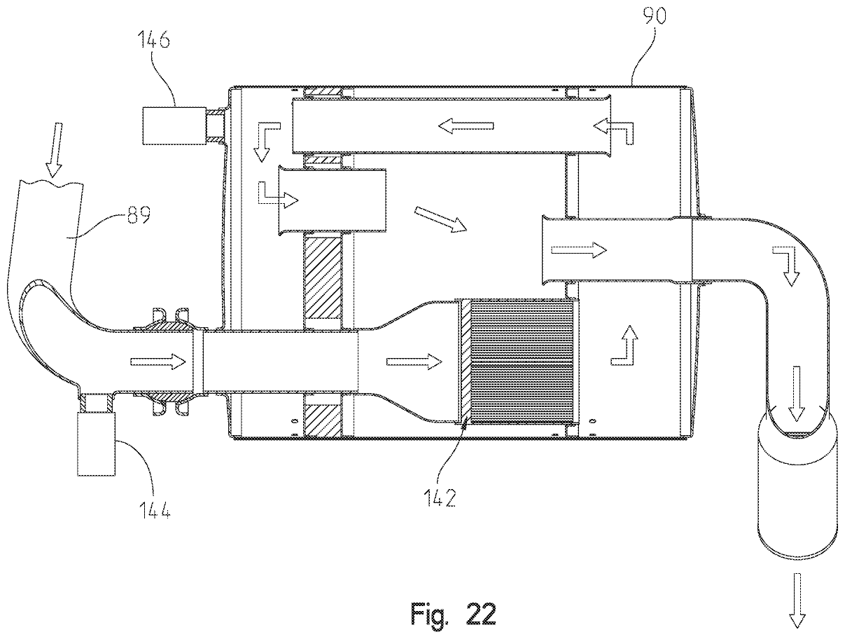

With reference now to FIGS. 21 and 22, exhaust assembly 76 may further include a catalyst 142 positioned adjacent or within muffler 90. Placement of catalyst 142 within muffler 90 allows catalyst 142 to be further removed or further downstream from exhaust of engine 72 than when catalyst 142 is positioned exterior to or upstream of muffler 90. In various embodiments, exhaust assembly 76 may also include a plurality of oxygen sensors, where a first oxygen sensor 144 of the plurality of oxygen sensors is positioned upstream of catalyst 142 and a second oxygen sensor 146 of the plurality of the oxygen sensors is positioned downstream of catalyst 142. First and second oxygen sensors 144 and 146 may be positioned within an interior of muffler 90 or may be positioned externally of muffler 90. In various embodiments, first oxygen sensor 144 may be coupled to exhaust conduit 89, while second oxygen sensor 146 may be coupled to muffler 90. The plurality of oxygen sensors allows the status and/or life of catalyst 142 to be monitored, for determining emissions parameters, by sensing and monitoring the amount of oxygen before exhaust gases flow into catalyst 142 and the amount of oxygen after exhaust gases flow out of catalyst 142.

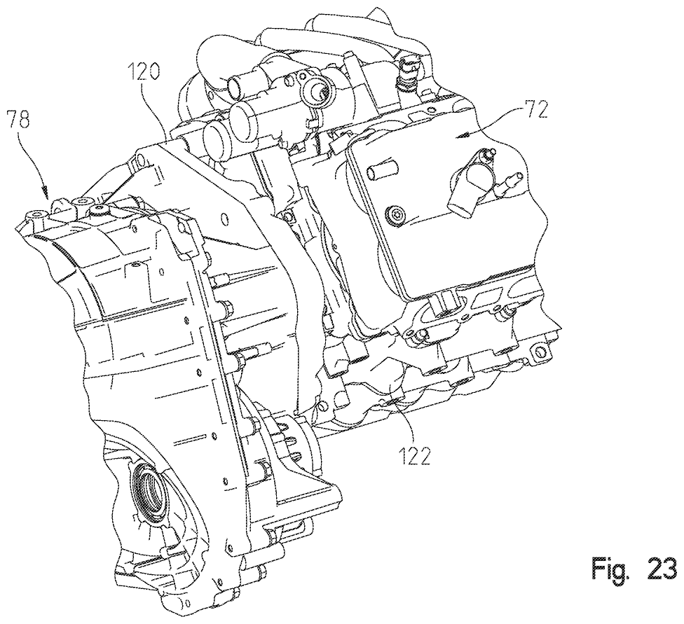

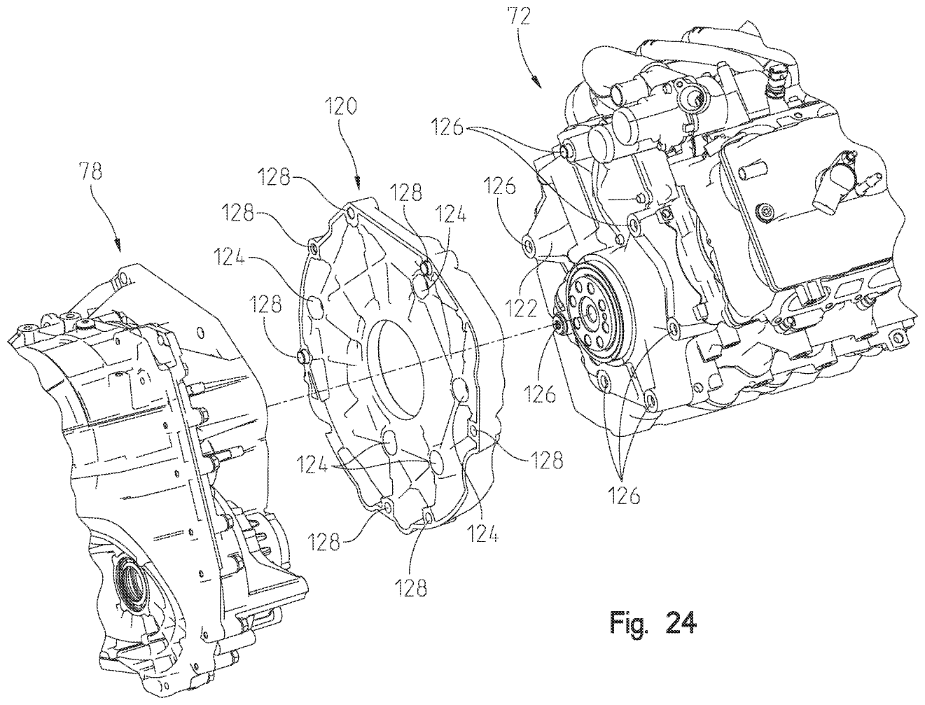

Referring now to FIGS. 23-25B, engine 72 includes an engine block 122 configured to be coupled to the various embodiments of transmission 78 discussed above without alterations of engine block 122 itself. For example, in various embodiments, when transmission 78 is a steel belt CVT, powertrain 70 may further include an adapter plate 120 configured to couple transmission 78 to engine 72 such that adapter plate 120 is positioned between or intermediate transmission 78 and engine 72 (FIGS. 23 and 24). Adapter plate 120 allows engine block 122 of engine 72 to remain the same for coupling with each of the various embodiments of transmission 78 discussed above, and allows engine 72 to be positioned at any angle relative thereto. More particularly, adapter plate 120 generally includes a first set of openings 124 configured to align with openings 126 of engine 72 and a second set of openings 128 configured to align with openings (not shown) in transmission 78, where the openings in transmission 78 and openings 126 of engine 72 are not aligned. In this way, the unaligned openings 124, 128 allow for engine 72 and transmission 78 to be at any orientation relative to each other, which, for example, allows for compact packaging of various components of vehicle 10 relative to powertrain 70 and allows for proper output shaft and driveline orientations.

Referring to FIGS. 25A and 25B, crankshaft 83 of engine 72 may be provided in two different configurations to further allow engine block 122 to remain the same while being used for different transmission types. For example, in various embodiments and referring to FIG. 25A, crankshaft 83 may include a bolted pattern 130 at a first end 132 of crankshaft 83 for coupling to a steel belt CVT, while in other embodiments and referring to FIG. 25B, crankshaft 83* may include a tapered extension 134 at first end 132* of crankshaft 83* for coupling to a rubber belt CVT. Outside of differing first ends 132, 132*, crankshafts 83 and 83* are substantially the same. In various embodiments, such as FIG. 25B, a second end 136 of crankshaft 83, 83* may be tapered such that crankshaft 83, 83* may be coupled to an internal charging system (not shown), while in other various embodiments, such as FIG. 25A, second end 136 of crankshaft 83, 83* may be straight such that crankshaft 83, 83* may be coupled to a pulley (not shown). The internal charging system may be an internal stator configured to couple with the tapered second end 136 of crankshaft 83, 83* (FIG. 25B) or may be an externally mounted alternator driven by a crankshaft pulley and operably coupled to the straight second end 136 of crankshaft 83, 83* (FIG. 25A).

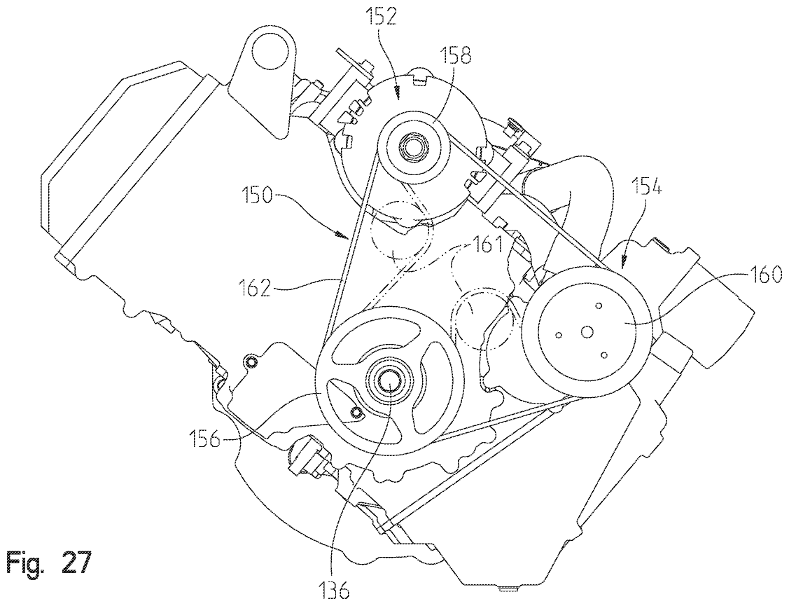

With reference to FIGS. 25A, 25B, and 26, crankshaft 83, 83* includes two journal bearings 129, which extend along a length of crankshaft 83, 83* and allow for second inlet 108 of transmission housing 100 to provide air flow to a backside of transmission 78. For example, as shown in FIG. 26, a first journal bearing 129a, in addition to a second journal bearing 129b, allows spacing for second inlet 108 of transmission 78 to provide air to an inner surface 131 of a drive clutch 133 of transmission 78. More particularly, first journal bearing 129a in addition to second journal bearing 129b spaces apart housing 100 of transmission 78 from engine block 122 such that air may flow therebetween. Such air in the spacing between engine block 122 and housing 100 of transmission 78 cools at least inner surface 131 of the inner sheave of drive clutch 133. Spacing created by journal bearings 129 may provide additional air passages 135 between transmission housing 100 and engine block 122.

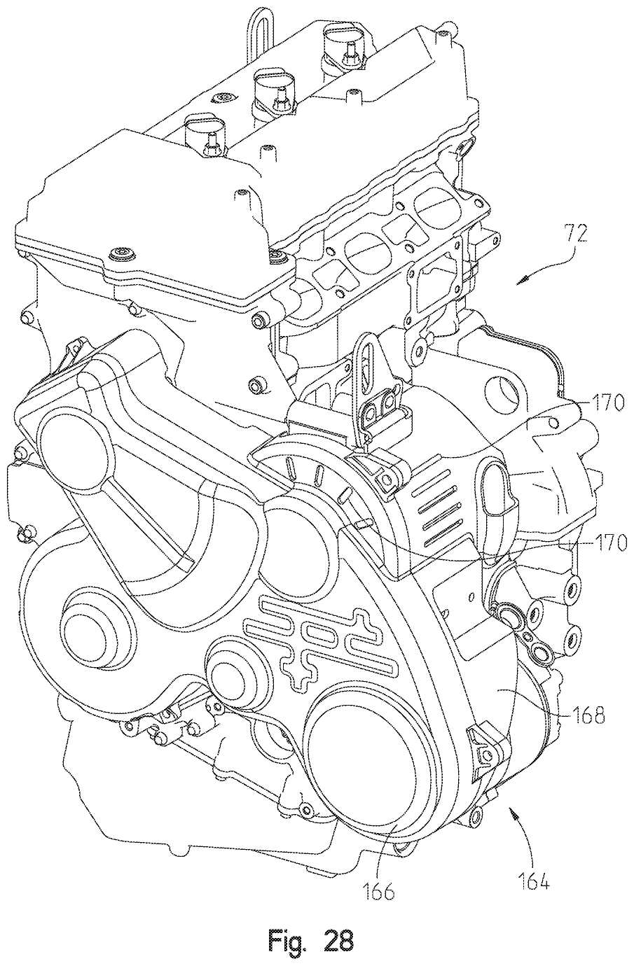

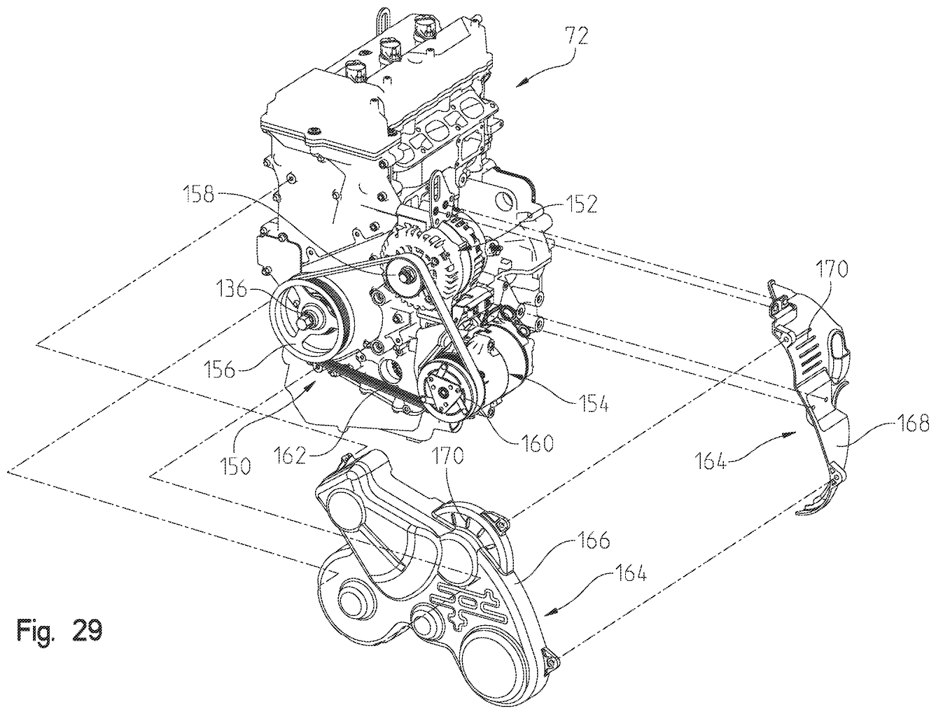

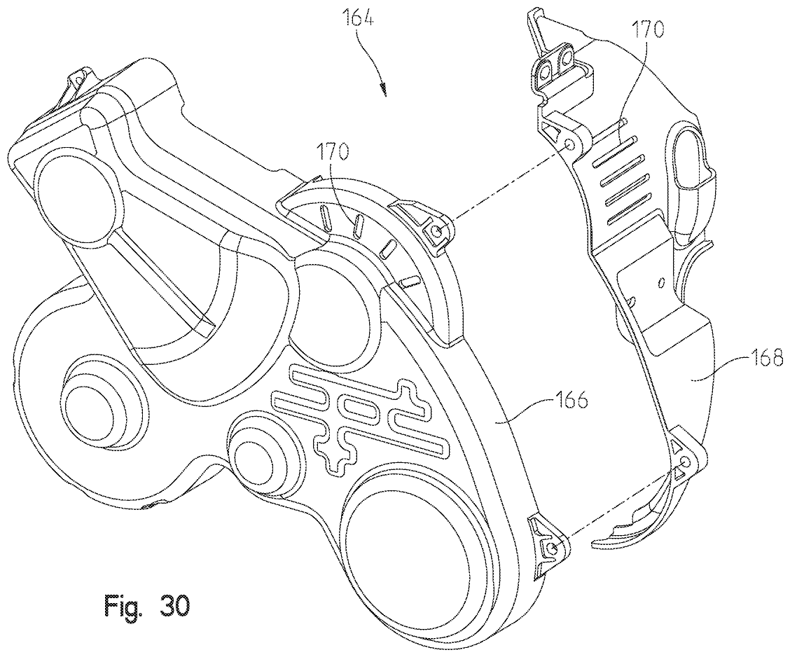

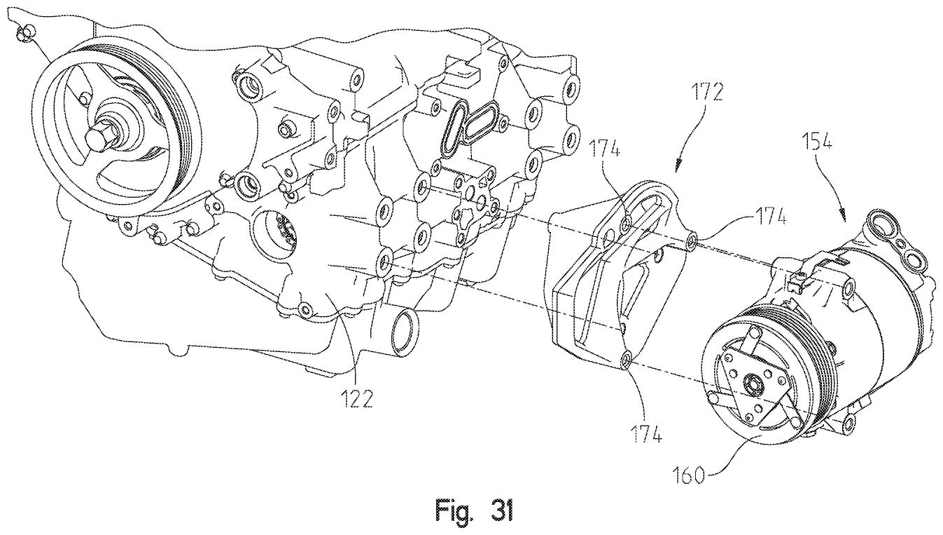

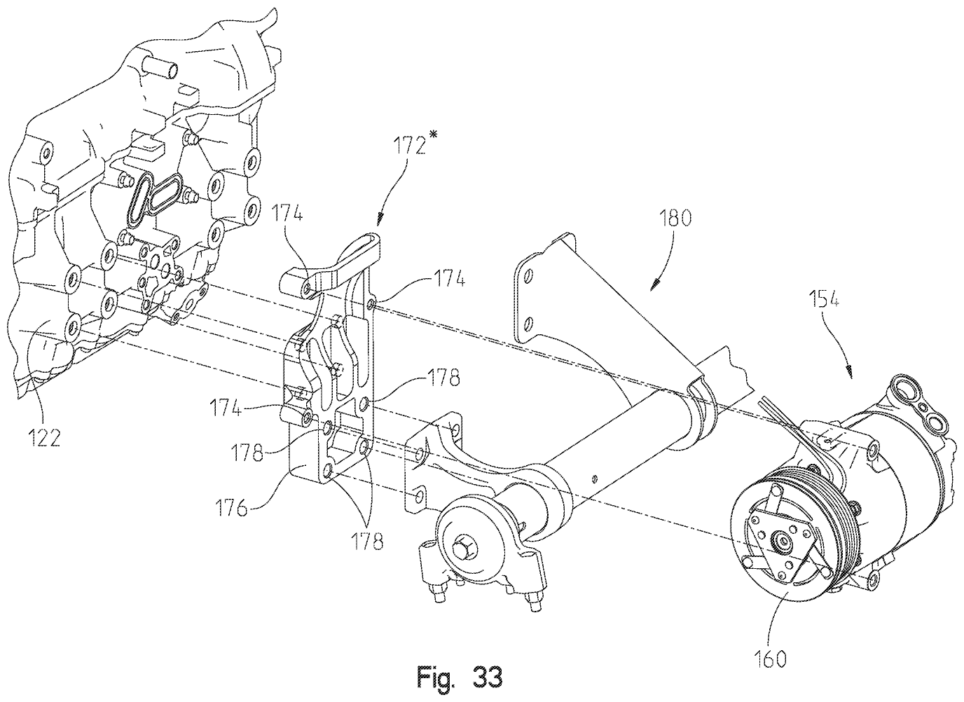

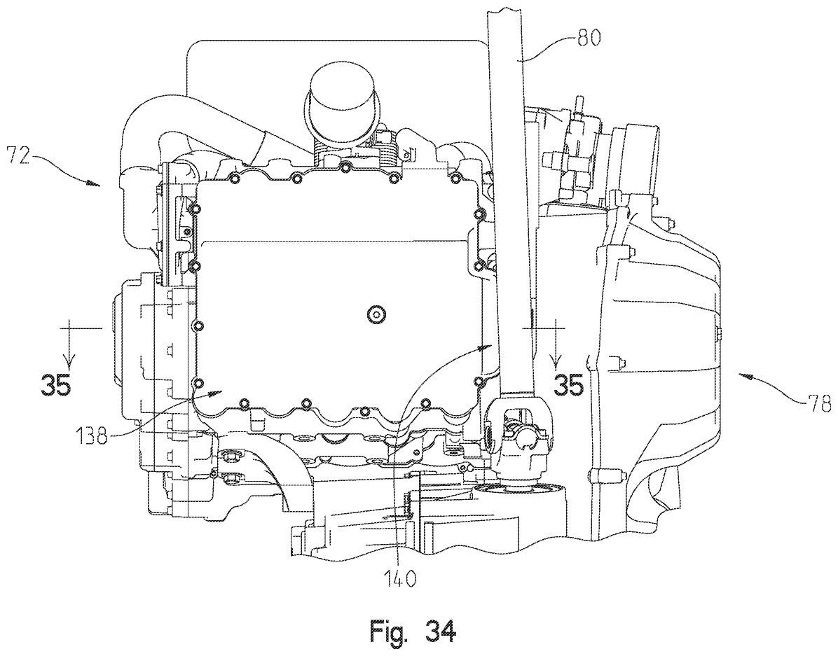

Referring now to FIGS. 27-33, second end 136 of crankshaft 83 may be coupled to and drive at least one accessory component via a belt drive or belt and pulley system 150. The accessory component may include an alternator 152, a compressor 154, and/or a hydraulic pump (not shown). As shown in FIGS. 27 and 29, belt and pulley system 150 includes a first pulley 156 coupled to second end 136 of crankshaft 83, a second pulley 158 coupled to alternator 152, a third pulley 160 coupled to compressor 154, and a single stretch belt 162 coupled to each of first, second, and third pulleys 156, 158, and 160 such that rotation of first pulley 156 via crankshaft 83 drives second and third pulley 158 and 160 via belt 162. Belt and pulley system 150 may also include one, two, or more idler pulleys 161 and/or tensioners around which belt 162 may also rotate. In various embodiments, belt and pulley system 150 may be concealed by a cover 164 (FIGS. 28-30) to protect belt and pulley system 150 from debris. Cover 164 may include a first portion 166 and a second portion 168, where first portion 166 covers pulleys 156, 158, 160 and belt 162 and second portion 168 covers side portions of alternator 152 and compressor 154. First portion 166 and/or second portion 168 may include a plurality of openings 170 to allow air flow to/from belt and pulley system 150. In addition, in various embodiments, one of pulleys 156, 158, 160 may include a fan (not shown) to provide air flow to belt and pulley system 150.

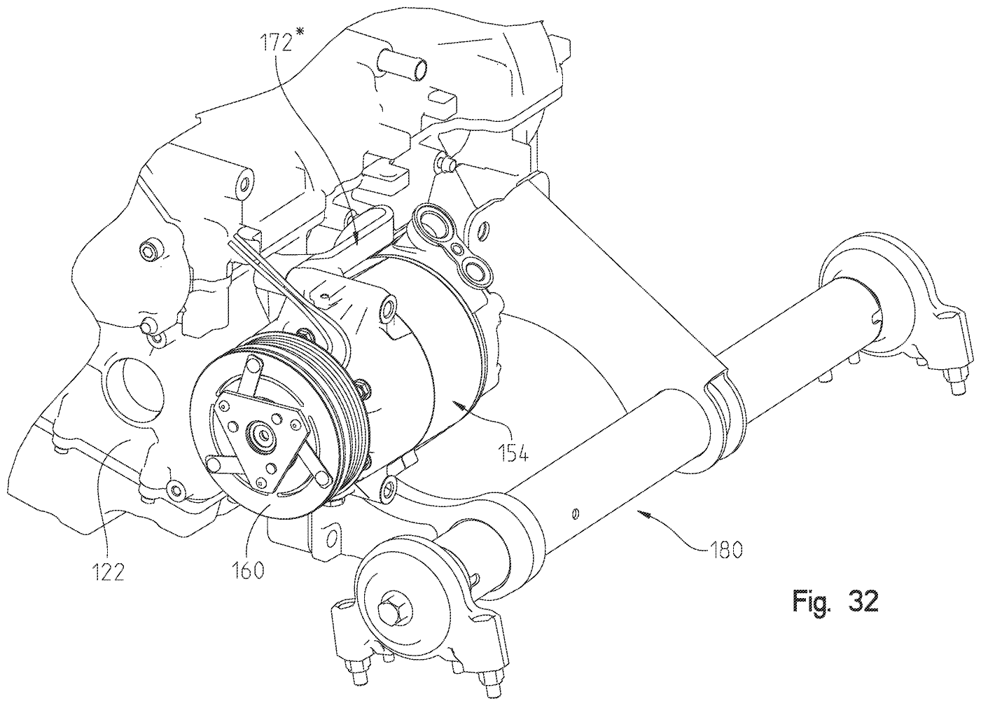

With reference to FIGS. 31-33, while alternator 152 and/or compressor 154 may be coupled directly to engine block 122, in various embodiments, alternator 152 and/or compressor 154 may require a casting or engine mount 172 for proper coupling and/or packaging. For example, and as shown in FIGS. 31-33, compressor 154 may be coupled to engine block 122 via casting or engine mount 172. Casting 172 generally includes a plurality of openings 174 for coupling compressor 154 to casting 172 and casting 172 to engine block 122. In various embodiments, an alternative casting 172* may include an extension 176 having a plurality of openings 178 for coupling an engine mount 180 to engine block 122 and for mounting engine 72 to frame 20. Additional details relating to the mounting of alternator 152 and/or compressor 154 may be found in U.S. patent application Ser. No. 15/631,874 (Attorney Docket Number PLR-06-28008.01P-US), filed Jun. 23, 2017, the subject matter of which is incorporated herein by reference.

Referring now to FIGS. 34 and 35, engine 72 may be adapted to allow for proper packaging of drive shaft 80 of the drivetrain. Specifically, an oil pan 138 of engine 72 may include a scalloped portion or cutout 140 such that drive shaft 80 can extend from engine 72 to couple with front ground engaging members 4 while remaining substantially parallel to a longitudinal axis of vehicle 2 and substantially aligned with an output shaft of the drivetrain (not shown).

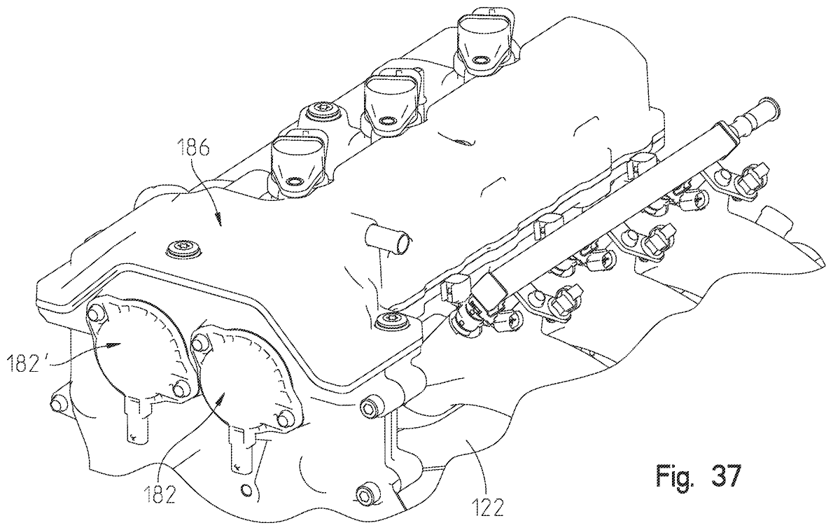

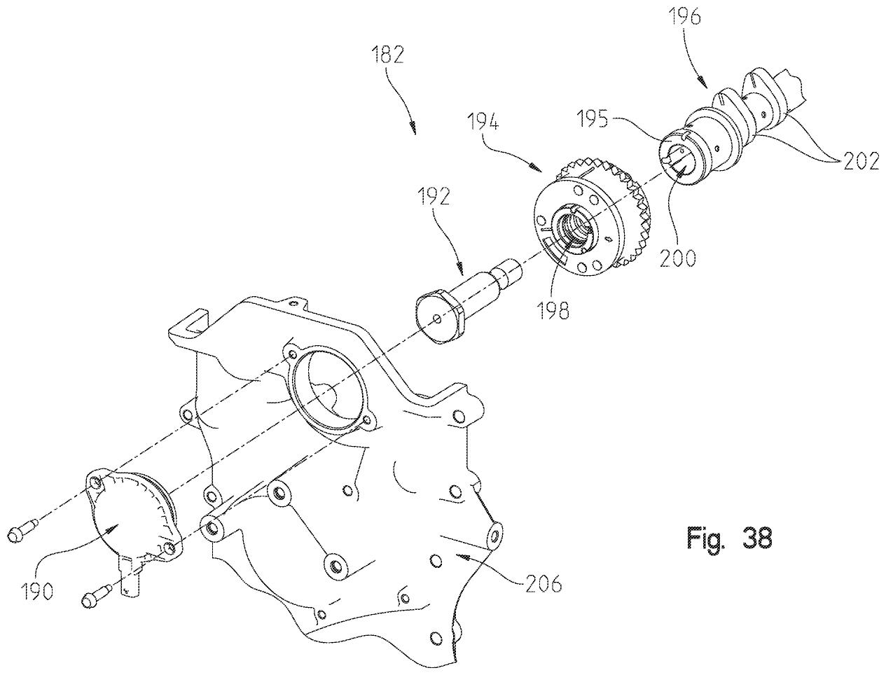

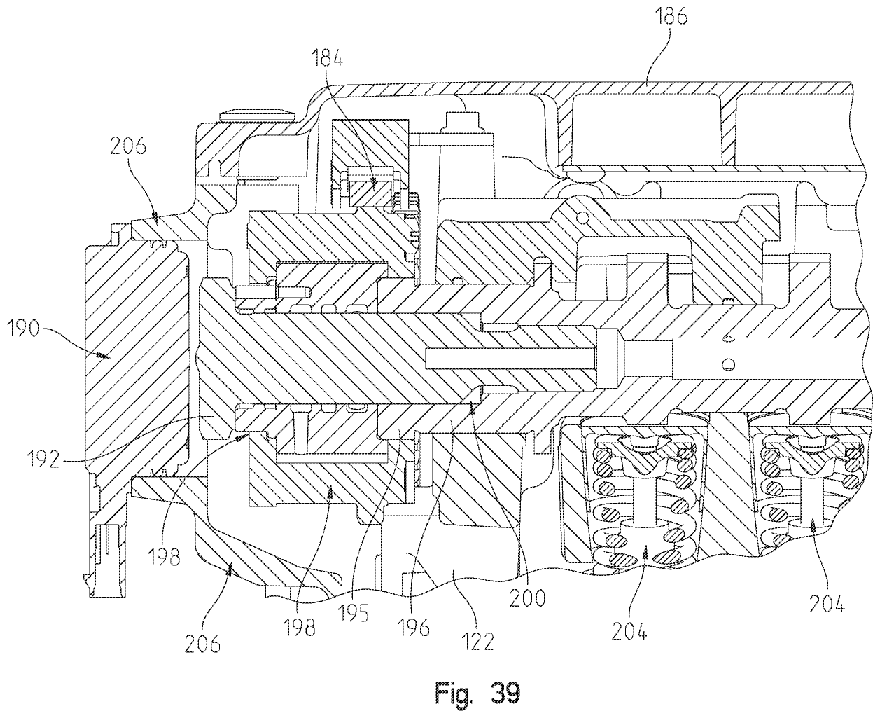

With reference now to FIGS. 36-39, in various embodiments, engine 72 may include a variable valve timing or phasing system 182 operably coupled to crankshaft 83 via a belt or chain 184 (FIG. 39). Variable valve phasing system 182 is generally positioned atop engine block 122 above cylinders 82 and protected by a cam cover 186, however, variable valve phasing system 182 also may be positioned on a portion of engine block 122 at a position generally adjacent crankshaft 83. In various embodiments, engine 72 may include a second variable valve phasing system 182', where one of variable valve phasing system 182 and 182′ is for the intake of engine 72 and the other of variable valve phasing system 182 and 182′ is for the exhaust of engine 72 (FIG. 37). In this way, the timing of the engine intake and/or the engine exhaust may be phased or otherwise adjusted, relative to the rotation of crankshaft 83, based on various operating conditions and parameters of powertrain 70 and vehicle 2. Furthermore, in various embodiments, a sealing arrangement (not shown) may be positioned between cam cover 186 and engine block 122.

Variable valve phasing system 182 is operably coupled to an intake cam shaft 196 and generally includes an actuator assembly 190, a phaser control valve 192, and a phaser module 194. Phaser control valve 192 generally extends through a central opening 198 in phaser module 194 and into a central opening 200 in intake cam shaft 196. Phaser module 194 couples with a portion 195 of intake cam shaft 196 such that intake cam shaft 196 may be decoupled from crankshaft 83. Intake cam shaft 196 includes lobes 202 configured to actuate valves 204 of engine 72. In various embodiments, actuator assembly 190 is supported by an engine cover 206 coupled to engine block 122, while in other various embodiments, actuator assembly 190 may be remote to engine block 122 and/or engine cover 206. When actuator assembly 190 is supported by engine cover 206, the sealing arrangement and cam cover 186 may be coupled over a portion of engine cover 206 in addition to engine block 122. Further details relating to the variable valve phasing system may be found in U.S. patent application Ser. No. 16/174,849 (Attorney Docket Number PLR-12-25833.02P-US), filed Oct. 30, 2018, the subject matter of which is incorporated herein by reference.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A utility vehicle, comprising:
a frame;
a body supported by the frame;
front and rear ground engaging members supporting the frame and the body; and
a powertrain drivingly coupled to the front and rear ground engaging members, the powertrain comprising a transmission and an engine, the engine having an engine block and a crankshaft, wherein the transmission includes one of a first type of transmission and a second type of transmission, the engine block being configured to couple to either of the first type of transmission and the second type of transmission without alteration of the engine block.
